(19) United States
(12) Patent Application Publication
(10) Pub. No.: US 2016/0239975 A1
(43) Pub. Date: Aug. 18, 2016

(54) HIGHLY ROBUST MARK POINT DECODING METHOD AND SYSTEM

(71) Applicant: SHENZHEN UNIVERSITY, Shenzhen (CN)

(72) Inventors: Xiaoli Liu, Shenzhen (CN); Mengting Yao, Shenzhen (CN); Yongkai Yin, Shenzhen (CN); Xiang Peng, Shenzhen (CN)

(21) Appl. No.: 15/140,534

(22) Filed: Apr. 28, 2016

Related U.S. Application Data
(63) Continuation of application No. PCT/CN2015/082453, filed on Jun. 26, 2015.

(30) Foreign Application Priority Data
Aug. 20, 2014 (CN) 201410413706.0

(51) Int. Cl. G06T 7/00

(52) U.S. Cl. CPC G06T 7/0061; G06T 7/0018; G06T 7/0075; G06T 2207/10028; G06T 2200/04

(57) ABSTRACT

The present invention provides a highly robust mark point decoding method and system. The decoding method comprises the following steps: step A, estimating a homography matrix and converting perspective projection images of mark points into orthographic projection images; step B, traversing coding segments of the mark points images in a polar coordinate system to obtain a pixel value in a cartesian coordinate system corresponding to each point, and determining the length of each coding segment and the code value thereof in a binary coding sequence, so as to determine the number of code value bits of each coding segment in the binary coding sequence to form a binary coding sequence; step C, performing cyclic shifting on the binary coding sequence, and converting each cyclic-shifted sequence into a decimal coded value, and marking the minimum decimal coded value as a coded value of the mark point.

### CROSS-REFERENCE TO RELATED APPLICATIONS

This present application is a Continuation Application of PCT application No. PCT/CN2015/082453 filed on Jun. 26, 2015, which claims the benefit of Chinese Patent Application No. 201410413706.0 filed on Aug. 20, 2014, the contents of which are hereby incorporated by reference.

### TECHNICAL FIELD

The present invention pertains to the technical field of image processing, and in particular, relates to a highly robust mark point decoding method and system, for registration and matching of three-dimensional profiles of large-size objects in a multi-sensor network.

### BACKGROUND

In computer vision and three-dimensional measurement, with respect to a large-size three-dimensional object, a complete three-dimensional profile can be obtained only after a plurality of image sensors collect data for the three-dimensional object from multiple angles. In such a multi-sensor network, the global matching method of a global control network is used to implement multi-view field matching by using the method of transforming the range data acquired from different perspectives to a uniform reference coordinate system. In this way, the matching precision is an important factor for improving the accuracy of registering of the three-dimensional data.

Artificial mark points, as a significant feature, are widely applied in three-dimensional imaging and modeling (3DIM) fields such as camera calibration, three-dimensional reconstruction, range data matching and the like. Circular mark points, featuring high precision and simplicity in identification, are widely applied.

Establishment of a point corresponding relationship (matching of corresponding points) between images in different views is a basis for the stereo vision-based three-dimensional reconstruction. However, an ordinary (non-coding) mark point is only a circular dot, which generally forms an ellipse on the image, and the mark points fail to be distinguished from each other in terms of morphology, thus the non-coding mark points may not be correspondingly matched in a stereo vision system without prior knowledge (subjected to no calibration). Therefore, mark points which are different in appearance—encoding mark points need to be developed, wherein different encoded values are defined for the mark points by means of appearance, such that each encoded mark point has unique identity information to determine a corresponding relationship between the encoded mark points. Since the last century, the encoded mark points have been widely applied in the digital close-range photogrammetry.

Design schemes of the encoded mark points mainly fall within two large categories: a concentric circle (ring) type as illustrated in FIG. 1a and FIG. 1b, and a distribution type as illustrated in FIG. 1c and FIG. 1d. In practical applications, the V-STAR system provided by American GSI Corporation employs the Hattori encoded mark point (as illustrated in FIG. 1c); the DPA-Pro system provided by German AICON 3D Corporation employs the Schneider mark points (as illustrated in FIG. 1b). At present, the DPA-Pro system has been integrated in related products by at least two companies:

(1) the TRITOP system provided by German GOM Corporation;

(2) the COMMET system provided by German Steinbichler Corporation.

Later, many experts and researchers at domestic and overseas carry out related studies. Based on the Schneider mark, expert Zhou in China has designed the mark point having double-layer coding ring band, and Zhang Yili from Shanghai Jiaotong University has designed the mark point with the coding ring being 14 equal parts spaced in “The Key Techniques Researches on Designs and Auto Detection of Referred-Point in Data Acquisition of Reverse Engineering”.

Therefore, if the error of the judgment of the coding feature region in the mark points caused by the image pickup perspective, camera resolution, noise and the like can be prevented, the decoding of the mark point may gain wider application.

### SUMMARY

A first technical problem to be solved by the present invention is to provide a highly robust mark point decoding method, to better avoid the error of the judgment of the coding feature region in the mark points caused by the image pickup perspective, camera resolution, noise and the like.

The present invention is implemented by a highly robust mark point decoding method, which comprises the following steps:

step A: estimating a homography matrix, and transforming a perspective projection image of the mark point into an orthographic projection image by using the estimated homography matrix;

step B: traversing a coding segment of the orthographic projection image of the mark point in a polar coordinate system to obtain a corresponding pixel value for each pixel point of the coding segment in a Cartesian coordinate system, judging a length of each coding segment according to distribution of the pixel values to determine a code value bit number occupied by each coding segment in a binary coding sequence, and using the pixel value of each coding segment as a code value of the coding segment in the binary coding sequence to form a binary coding sequence for representing the coding value of the mark point in the Cartesian coordinate system;

wherein the image of the mark point is an annular dual-value coding image, and when the image of the mark point is partitioned into N equal parts with equal angle, each equal part is used as a pixel value coding bit, and each coding segment comprises at least one equal part;

step C: subjecting the binary coding sequence to cyclic shift, converting a shifted sequence into a decimal coding value, and finally marking a minimum decimal coding value as the coding value of the mark point.

Further, the homography matrix in step A is estimated by using the following five points: two intersection points between the long axis and the edge of the ellipse image, two intersection points between the short axis and the edge of the ellipse and a central point of the ellipse.

Further, in step B, the image containing a plurality of mark points is mapped from polar coordinate system to the Cartesian coordinate system by using the following formulae:

X=x₀+r×cos(theta);

Y=y₀+r×sin(theta);

wherein x₀ is a central x-coordinate of polar coordinate transformation, y₀ is a central y-coordinate of polar coordinate transformation, r indicates a polar radius, and theta indicates a polar angle, the polar radius r being within a range of the image of the mark point.

Further, the polar radius r has a value domain r∈[2R, 3R], R is a central circle radius of the image of the mark point, and the polar angle theta has a value selected from theta∈[1°, 360°].

Further, the traversing a coding segment in step B specifically comprises:

traversing a coding segment of an orthographic projection image of the mark point by using the polar radius r as a constant and using 360 angle values obtained by even partition of the polar angle theta by 1 degree equal interval as variables; wherein the polar radius r=2.5 R.

Further, a ratio of the central circle radius of the image of the mark point to a coding ring band inner radius to a coding ring band outer radius is 1:2:3.

The second technical problem to be solved in the present invention is to provide a highly robust mark point decoding system, which comprises the following modules:

a perspective projection transforming module, configured to transform a perspective projection image of the mark point into a orthographic projection image by using an estimated homography matrix;

a coordinate transforming module, configured to traverse a coding segment of the orthographic projection image of the mark point in a polar coordinate system to obtain a corresponding pixel value of each pixel point of the coding segment in a Cartesian coordinate system, to judge a length of each coding segment according to distribution of the pixel values to determine a code value bit number occupied by each coding segment in a binary coding sequence, and use the pixel value of each coding segment as a code value of the coding segment in the binary coding sequence to form a binary coding sequence for representing the coding value of the mark point in the Cartesian coordinate system; wherein the image of the mark point is an annular dual-value coding image, and when the image of the mark point is partitioned into N equal parts with an equal angle, each equal part is used as a pixel value coding bit, and each coding segment comprises at least one equal part;

a decoding marking module, configured to subject the binary coding sequence to cyclic shift, convert a shifted sequence into a decimal coding value, and finally mark a minimum decimal coding value as the coding value of the mark point.

Further, the coordinate transforming module maps an image comprising a plurality of mark points from the polar coordinate system to the Cartesian coordinate system by using the following formulae:

X=x₀+r×cos(theta);

Y=y₀+r×sin(theta);

wherein x₀ is a central x-coordinate of polar coordinate transformation, y₀ is a central y-coordinate of polar coordinate transformation, r indicates a polar radius, and theta indicates a polar angle, the polar radius r being within a range of the image of the mark point.

In the present invention, the homography matrix transformation can effectively eliminate the impacts caused by the inclined pickup perspective, and the polar coordinates have rotational invariance, thereby eliminating the impacts caused by rotation. Over-sampling of the coding ring band also eliminates the adverse effects caused by the camera resolution and noise. Therefore, wide applicability may be achieved while high robustness is ensured, and the error of the judgment of the coding feature region in the mark points caused by the image pickup perspective, camera resolution, noise and the like can be avoided.

### BRIEF DESCRIPTION OF THE DRAWINGS

FIG. 1a and FIG. 1b are schematic diagrams illustrating a concentric circle (ring) design of a encoded mark point.

FIG. 1c and FIG. 1d are schematic diagrams illustrating a distributed design of the encoded mark points.

FIG. 2 is a flowchart illustrating implementation of a highly robust decoding method for an annular coding mark point according to the present invention.

FIG. 3a is a design principle diagram illustrating a coding mark point according to the present invention.

FIG. 3b is a schematic diagram illustrating a mark point designed based on the principles illustrated in FIG. 3a according to the present invention.

FIG. 4 is an image picked up from a somewhat inclined and rotated angle for a target on which a mark point according to the present invention is attached.

FIG. 5 and FIG. 6 are diagrams illustrating coordinate transformation according to the present invention.

FIG. 7 is a schematic diagram illustrating a mark point having a coding value of 1463 according to the present invention.

FIG. 8 is a flowchart illustrating decoding of the mark point illustrated in FIG. 7.

FIG. 9 is a schematic diagram illustrating a decoding result of the image illustrated in FIG. 4.

FIG. 10 is a diagram illustrating logical structure of a highly robust decoding system for an annular coding mark point according to the present invention.

FIG. 11 is a schematic diagram of an orthographic projection transformed by a perspective projection according to the present invention.

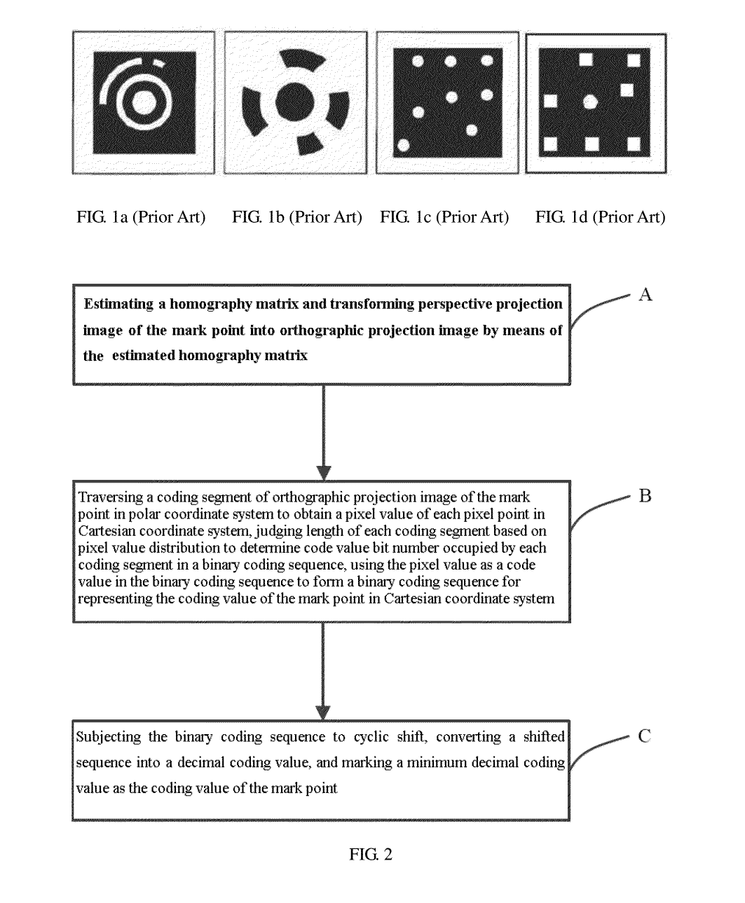

### DETAILED DESCRIPTION OF THE EMBODIMENTS

To make the objectives, technical solutions, and advantages of the present invention clearer, the present invention is further described with reference to specific embodiments and attached drawings. It should be understood that the embodiments described here are only exemplary ones for illustrating the present invention, and are not intended to limit the present invention.

According to the present invention, the Schneider coding pattern that features practicability and extensibility used as a basis for research, and the used decoding method has wide applicability while ensuring high robustness. In this way, no matter 12 equal partitions or 14 equal partitions, or even finer partitioning of the coding ring is made, high decoding accuracy can always be achieved.

FIG. 2 is a flowchart illustrating implementation of a highly robust decoding method for an annular coding mark point according to the present invention, which is detailed as follows.

Step A: A homography matrix is estimated, and a perspective projection image of the mark point is transformed into an orthographic projection image by using the estimated homography matrix.

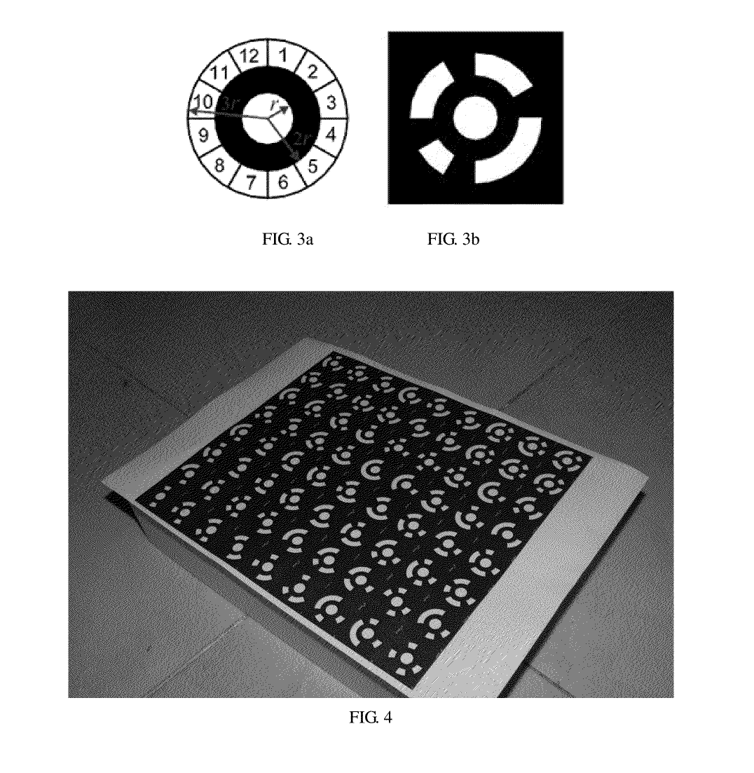

In the present invention, the image of a mark point is an annular binary coding image; when the image of the mark point is partitioned into N equal parts, each equal part is used as a pixel value coding bit. As illustrated in FIG. 3a, the ring enclosing the center is a coding feature region—a coding ring band, which is partitioned into N equal parts by an equal angle (referred to as N bits coding). Each equal part is referred to as a coding bit, and each coding bit may be taken as a binary bit, wherein black denotes 0 and white denotes 1. In this way, each mark point may be decoded into an N-bit binary code, and a ratio of the central circle radius of the image of the mark point to a coding ring inner radius to a coding ring outer radius is 1:2:3. In FIG. 3b illustrating the mark point designed based on the design principles illustrated in FIG. 3a, each white coding segment may comprise at least one above-described equal part.

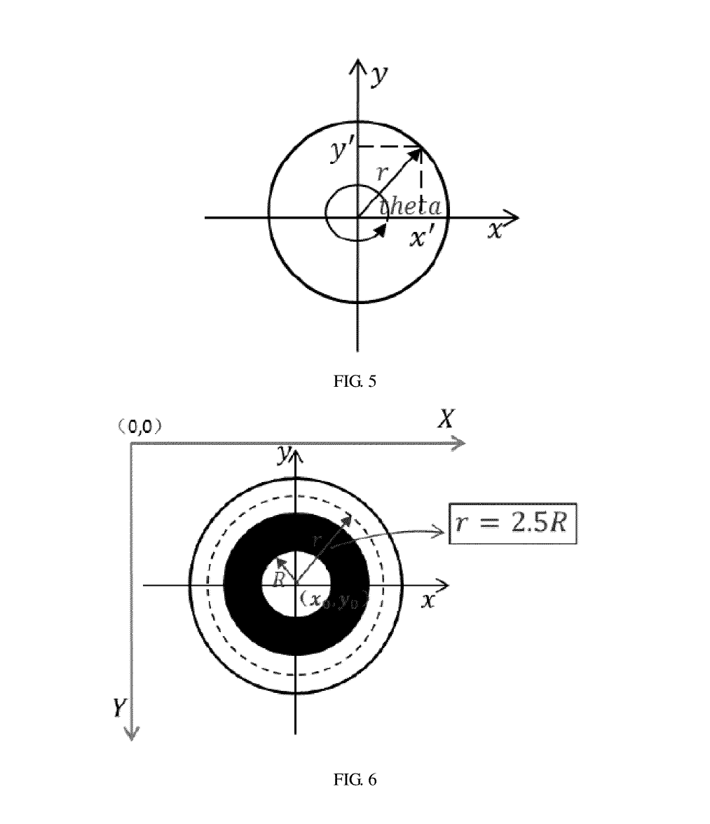

The above mark point may be generated by using a mark point generator of the software AICON. A set of mark points having different coding values generated by the mark point generator of the software AICON are stuck on the target, the target carrying the mark points is shot for picking up images by means of a camera (for example, a single lens reflex camera), and then the collected images are transmitted to a computer. In the present invention, the target having 72 different mark points is shot for picking up images from a somewhat inclined and rotated angle, as illustrated in FIG. 4.

Then, edge detection is performed for the collected images, and noise and non-target objects are filtered based on a series of restrictions and criteria, and the identification of the target is completed. Afterwards, sub-pixel positioning is performed for the edges of the picked up image of the mark point, wherein the positioning process is as follows:

Step 1: The edge detection is performed for the mark point by using the Canny operator;

Step 2: According to such restrictions as the length criterion (the number of edge pixels of the mark point), the closing criterion, the luminance criterion and the shape criterion, an image comprising only edges of the mark points is obtained;

Step 3: Based on the sub-pixel center positioning algorithm of the curve surface fitted circular mark point, sub-pixel center positioning is performed by using the edge sub-pixel positioning in combination with the elliptic curve fitting method and the curve fitting method;

Sub-pixel edge positioning: cubic polynomial curve surface fitting is performed for the 5×5 neighborhood of each pixel at the pixel-level edge, and the position of the local extremum of the first-order derivative of the curve surface is acquired, that is, the sub-pixel position.

Assume that the model of the image neighborhood is:

f(x,y)=k₁+k₂x+k₃y+k₄x²+k₅xy+k₆y²+k₇x³+k₈x²y+k₉xy²+k₁₀y³,

wherein x and y are the relative coordinates using the image point (x₀, y₀) for fitting as the origin, f(x, y) is an image grey value at the point (x₀+x, y₀+y), and the coefficient kᵢ(i=1, . . . , 10) is solved by using the linear least square method.

The first-order derivative and the second-order derivative of the function in the direction of θ are calculated by the following formulae:

$$\frac{\partial f}{\partial θ} = \frac{\partial f ( x , y )}{\partial x} sin θ + \frac{\partial f ( x , y )}{\partial y} cos θ$$

$$\frac{{\partial }^{2} f}{\partial {θ}^{2}} = \frac{{\partial }^{2} f ( x , y )}{\partial {x}^{2}} {sin}^{2} θ + 2 \frac{{\partial }^{2} f ( x , y )}{\partial x \partial y} sin θ cos θ + \frac{{\partial }^{2} f ( x , y )}{\partial {y}^{2}} {cos}^{2} θ .$$

It may be solved that the sub-pixel potion of the edge point is (x₀+ρcosθ, y₀+ρsinθ).

Sub-pixel center positioning: the equation of the least squares fitting ellipse is carried out for all the obtained elliptic sub-pixel edges, to obtain the center position of the mark point.

The general equation of the planar ellipse is:

x²+2Bxy+Cy²+2Dx+2Ex+F=0

Five parameters B, C, D, E, and F may be obtained by calculation via fitting, and the coordinates of the ellipse center are:

$${x}_{0} = \frac{BE - CD}{C - {B}^{2}} , {y}_{0} = \frac{BD - E}{C - {B}^{2}} .$$

The geometry of imaging is essentially a perspective projection. Therefore, the circle is projected as an ellipse onto the image, and the projections of the centroid and center of the ellipse on the image are subject to a deviation. Accordingly, the imaging position using the centroid of the mark point image (ellipse) obtained by processing with the mark point center (centroid) positioning algorithm as the center of the mark point is subject to a system error.

Deviation analysis is made by using the formulae given by Ahn in “Systematic geometric image measurement errors of circular object targets: Mathematical formulation and correction” (The Photogrammetric Record, 16(93): 485-502); and deviation correction is performed by using the formulae given by Heikkil in “A four-step camera calibration procedure with implicit image correction” (IEEE Computer Society Conference, 1997, Proceedings. 1106-1112). The correction of the central positioning deviation of the mark point is implemented with reference to the positioning error model given by Heikkil and the camera calibration based on circle given in Chen's “Camera calibration with two arbitrary coplanar circles” (Computer Vision-ECCV, 2004, 521-532).

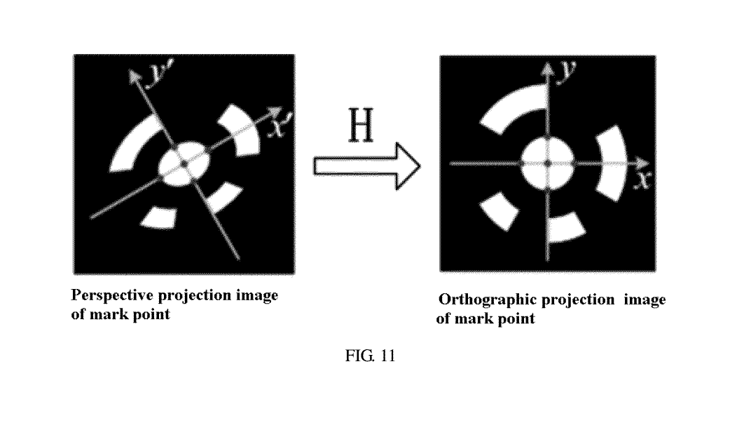

As known from the camera model, plane-to-plane perspective projection transformation in the space is achieved between the coding mark point and the image thereof, therefore, their transformation relationship may be described by using a homography matrix H. As illustrated in FIG. 11, two intersection points between the long axis and the edge of ellipse, two intersection points between the short axis and the edge of ellipse, and a central point of ellipse (that is, the center of the mark point) (the five red dots in (a)) respectively correspond to four edge points of the circle in the horizontally vertical direction and the center of the circle (the five red dots in (b)). The homography matrix H may be estimated by using the five pair of corresponding points. Transformation is applied to each pixel of the image by using the homography matrix, which may correct the practical image (ellipse) of the mark point into an orthographic projection image (circle). The mathematic expression of the homography matrix is estimated as follows:

Step 1: A homography matrix H is estimated.

$${arg}_{H} min {\sum }_{i = 1}^{5} ‖ \tilde{{p}_{i}} - H \tilde{{q}_{i}} ‖ ,$$

[symbol]

: ideal coordinates, [symbol] : practical coordinates.

Step 2: The homography matrix is applied to each pixel point.

lₚ=H*l_{q}, lₚ denotes an orthographic projection image after the transformation, and I_{q} denotes a perspective projection image before the transformation.

step B: A coding segment of the image of the mark point is traversed in a polar coordinate system according to specific rules to obtain a corresponding pixel value of each pixel point of the coding segment in a Cartesian coordinate system, a length of each coding segment is judged according to distribution of the pixel values to determine a code value bit number occupied by each coding segment in a binary coding sequence, and the pixel value of each coding segment is determined by using a code value of the coding segment in the binary coding sequence to form a binary coding sequence for representing the coding value of the mark point in the Cartesian coordinate system.

In the present invention, the Log Polar transformation, i.e., the polar coordinate transformation, is specifically used, and the image in the Cartesian coordinate system is mapped to the polar coordinate system. Slightly different from the Log Polar transformation, in the present invention, the image is mapped from (x, y) to (r, theta) as illustrated in FIG. 5, whereas in the Log Polar transformation, the image is mapped from (x, y) to (log(r), theta). The transformation formulae are as follows:

x′=r×cos(theta);

y′=r×sin(theta);

wherein r denotes a polar radius and theta denotes a polar angle.

Since the coding feature region of the mark point is operated, the polar radius needs to be within the range of the coding ring band, and r∈[2R, 3R], wherein R denotes a central circle radius. The polar values are respectively an inner ring edge and an outer ring edge of the coding ring. Through the above steps, after the mark point is identified and extracted, the edge value is not reliable. Therefore, an intermediate value r=2.5 R is taken as the transformation polar radius, that is, the constant used in the process of traversing the coding segments. The central angle of the coding ring is 360 degrees, and therefore the polar angle theta has a value theta∈[1, 360], and 360 angle values obtained by even partition of the polar angle theta by 1 degree are used as variables during the process of traversing the coding segments.

In consideration of the origin of the Cartesian coordinate system of the image is defaulted at the left upper top portion of the image, and the vertical axis is downward, whereas the center of the polar coordinate transformation is set at the center of the mark point. Therefore, the central coordinates (x₀, y₀) of the polar coordinate transformation need to be added to (x, y) as an offset. In this way, the polar coordinate system correctly corresponds to the Cartesian coordinate system, and thus the transformation is implemented, as illustrated in FIG. 6.

The transformation formulae are as follows:

X=x₀+r×cos(theta); wherein x₀ denotes a central x-coordinate of polar coordinate transformation;

Y=y₀+r×sin(theta); wherein y₀ denotes a central y-coordinate of polar coordinate transformation.

In the present invention, all the pixel values are stored in an array Num[i] (i∈[1, 360]), the length of the array is 360. Since it is a binary image, Num[i]=1 denotes a white coding zone, and Num[i]=0 denotes a black non-coding zone. Each segment of coding zone may generate the identical and contiguous pixel values with the number of K. The number of pixels K in each coding zone is stored in an array Length[i]. Since the coding is cyclic coding, the number of pixels at the head is combined with the number of pixels at the tail.

Assume that n=360/Nbits is the number of pixel values in each unitary coding zone, when Length [i]=k*n=K, Length [i] corresponds to k contiguous coding values “1” or “0” in the Nbits coding sequence. However, whether the coding value being “1” or “0” is determined by the pixel value of this segment. In this way, an Nbits binary coding sequence representing the coding value of the mark point is formed.

In Step C, the binary coding sequence is subjected to cyclic shift, each shifted sequence is converted into a decimal coding value, and finally a minimum decimal coding value is marked as the coding value of the mark point.

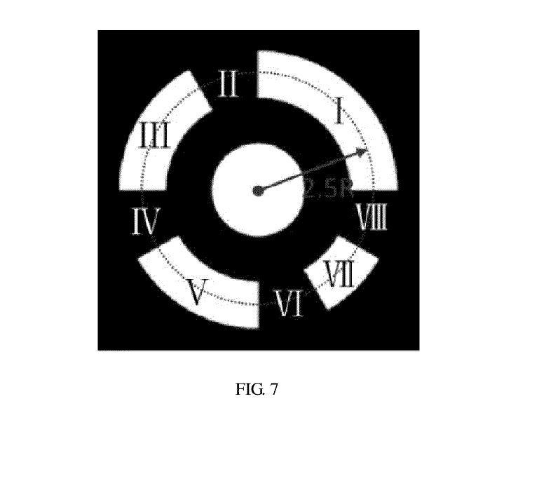

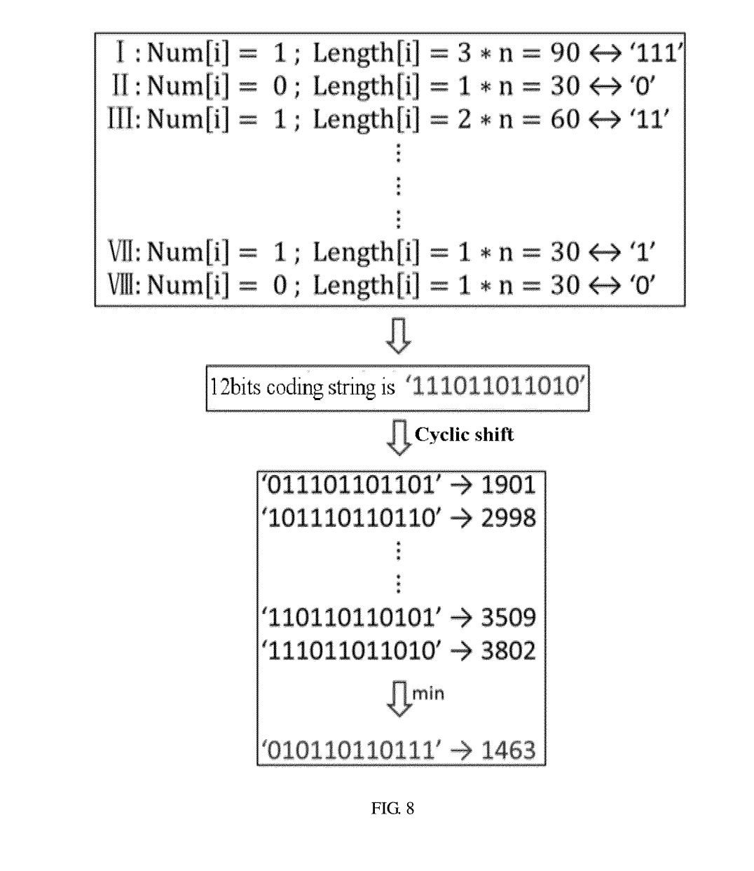

The minimum value obtained through binary coding string cyclic shift is used as the coding value of the mark point, such that the mark point has unique identity information. Using the mark point having a coding value of 1463 illustrated in FIG. 7 as an example, there are totally eight coding segments, and the number of pixel values of the unitary coding ring of a 12-bit mark point n=360/12=30. FIG. 8 illustrates a cyclic shift process of a binary coding sequence. As seen from FIG. 8, during the cyclic shift process, values such as 1901, 2998, 3509, and 3802 are obtained, wherein the minimum value 1463 is rightly the coding value of the mark point, such that the mark point has unique identity information.

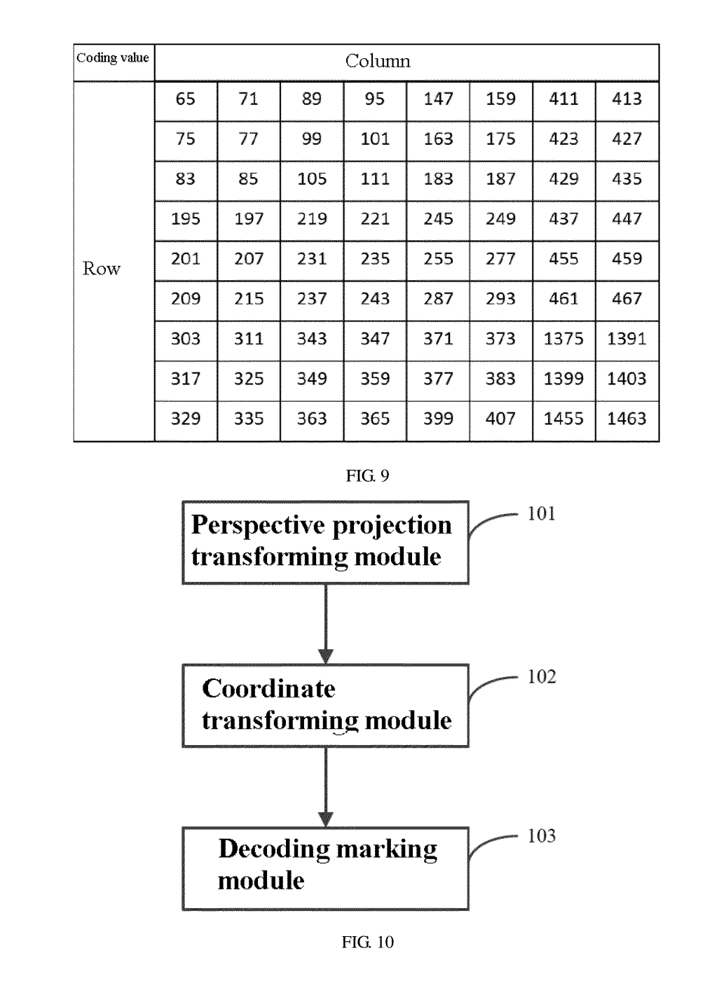

The mark points in the target as illustrated in FIG. 4 are decoded by using the above described decoding method, and the decoding result is as illustrated in FIG. 9. Through comparison between the decoded values and the correct coding values, the decoding accuracy reaches 100%.

FIG. 10 is a diagram illustrating logical structure of a highly robust mark point decoding system according to the present invention. For ease of description, parts relevant to this embodiment are only illustrated in FIG. 10.

Referring to FIG. 10, the highly robust decoding system comprises a perspective projection transforming module 101, a coordinate transforming module 102, and a decoding marking module 103. The perspective projection transforming module 101 is configured to transform a perspective projection image of the mark point into a orthographic projection image by means of a homography matrix H. The coordinate transforming module 102 is configured to traverse a coding segment of the orthographic projection image of the mark point in a polar coordinate system to obtain a pixel value of each pixel point of the coding segment in a Cartesian coordinate system, judge a length of each coding segment according to distribution of the pixel values to determine a code value bit number occupied by each coding segment in a binary coding sequence, and determine, based on the pixel value of each coding segment, a code value of the coding segment in the binary coding sequence to form a binary coding sequence for representing the coding value of the mark point in the Cartesian coordinate system. As described above, the image of the mark point is an annular dual-value coding image, and when the image of the mark point is divided into N equal parts with an equal angle, each equal part is used as a pixel value coding bit, and each coding segment comprises at least one equal part.

Finally, the decoding marking module 103 subjects the binary coding sequence to cyclic shift, converts a shifted sequence into a decimal coding value, and finally marks a minimum decimal coding value as the coding value of the mark point.

The principles of coordinate transformation performed by the coordinate transforming module 102, and the principles of designing the image of the mark point are as described above, which are thus not described herein any further.

In conclusion, the decoding method for a mark point having a coding feature achieves higher robustness, and is slightly subject to such factors as the image pickup perspective, camera resolution, noise and the like and may be used for registering and matching of three-dimensional profiles of large-size objects in a multi-sensor network.

Described above are merely preferred embodiments of the present invention, but are not intended to limit the present invention. Any modification, equivalent replacement, or improvement made without departing from the spirit and principle of the present invention should fall within the protection scope of the present invention.

What is claimed is:

1. A highly robust mark point decoding method comprising the following steps:
step A: estimating a homography matrix, and transforming a perspective projection image of a mark point into a orthographic projection image by using an estimated homography matrix;
step B: traversing a coding segment of the orthographic projection image of the mark point in a polar coordinate system to obtain a corresponding pixel value of each pixel point of the coding segment in a Cartesian coordinate system, judging a length of each coding segment based on distribution of the pixel values to determine a code value bit number occupied by each coding segment in a binary coding sequence, and using the pixel value of each coding segment as a code value of the coding segment in the binary coding sequence to form a binary coding sequence for representing the coding value of the mark point in the Cartesian coordinate system;
wherein the image of the mark point is an annular dual-value coding image, and when the image of the mark point is partitioned into N equal parts with an equal angle, each equal part is used as a pixel value coding bit, and each coding segment comprises at least one equal part; and
step C: subjecting the binary coding sequence to cyclic shift, converting a shifted sequence into a decimal coding value, and finally marking a minimum decimal coding value as the coding value of the mark point.

2. The highly robust mark point decoding method according to claim 1, wherein the homography matrix in step A is estimated by means of the following five points: two intersection points between a long axis and an edge of a ellipse, two intersection points between a short axis and the edge of the ellipse, and a central point of the central ellipse.

3. The highly robust mark point decoding method according to claim 1, wherein in step B, the polar coordinate system is mapped to the Cartesian coordinate system with the following formulae:
X=x₀+r×cos(theta);
Y=y₀=r×sin(theta);
wherein x₀ is a central x-coordinate of a polar coordinate transformation, y₀ is a central y-coordinate of the polar coordinate transformation, r indicates a polar radius, and theta indicates a polar angle, the polar radius r being within a range of the image of the mark point.

4. The highly robust mark point decoding method according to claim 3, wherein the polar radius r has a value selected from r∈[2R, 3R], R being a central circle radius of the image of the mark point; and the polar angle theta has a value selected from theta∈[1°, 360°].

5. The highly robust mark point decoding method according to claim 4, wherein the traversing a coding segment in step B comprises:
traversing a coding segment of a orthographic projection image of the mark point by using the polar radius r as a constant and using 360 angle values obtained by even partition of the polar angle theta by 1 degree as variables; wherein the polar radius r=2.5 R.

6. The highly robust mark point decoding method according to claim 1, wherein a ratio of the central circle radius of the image of the mark point to a coding ring inner radius to a coding ring outer radius is 1:2:3.

7. A highly robust mark point decoding system comprising the following modules:
a perspective projection transforming module, configured to transform a perspective projection image of a mark point into an orthographic projection image by means of an estimated homography matrix;
a coordinate transforming module, configured to traverse a coding segment of the orthographic projection image of the mark point in a polar coordinate system to obtain a pixel value of each pixel point of the coding segment in a Cartesian coordinate system, judge a length of each coding segment based on the distribution of the pixel values to determine a code value bit number occupied by each coding segment in a binary coding sequence, and use the pixel value of each coding segment as a code value of the coding segment in the binary coding sequence to form a binary coding sequence for representing the coding value of the mark point in the Cartesian coordinate system; wherein the image of the mark point is an annular dual-value coding image, and when the image of the mark point is partitioned into N equal parts with an equal angle, each equal part is used as a pixel value coding bit, and each coding segment comprises at least one equal part; and
a decoding marking module, configured to subject the binary coding sequence to cyclic shift, convert a shifted sequence into a decimal coding value, and mark a minimum decimal coding value as the coding value of the mark point.

8. The highly robust mark point decoding system according to claim 7, wherein the coordinate transforming module maps the image comprising a plurality of mark points from the polar coordinate system to the Cartesian coordinate system by means of the following formulae:
X=x₀+r×cos(theta);
Y=y₀=r×sin(theta);
wherein x₀ is a central x-coordinate of a polar coordinate transformation, y₀ is a central y-coordinate of the polar coordinate transformation, r indicates a polar radius, and theta indicates a polar angle, the polar radius r being within a range of the image of the mark point.

9. The highly robust mark point decoding system according to claim 8, wherein the polar radius r has a value selected from r∈[2R, 3R], R being a central circle radius of the image of the mark point; the polar angle theta has a value selected from theta∈[1°, 360°]; and a ratio of the central circle radius of the image of the mark point to a coding ring inner radius to a coding ring outer radius is 1:2:3.

10. The highly robust mark point decoding system according to claim 9, wherein the coordinate transforming module traverses a coding segment of an orthographic projection image of the mark point by using the polar radius r as a constant and using 360 angle values obtained by even partition of the polar angle theta by 1 degree as variables; wherein the polar radius r=2.5 R.
